(19) United States
(12) Patent Application Publication
(10) Pub. No.: US 2019/0208750 A1
(43) Pub. Date: Jul. 11, 2019

(54) METHODS AND SYSTEMS FOR MANAGING AQUACULTURE PRODUCTION

(71) Applicant: INTERNATIONAL BUSINESS MACHINES CORPORATION, Armonk, NY (US)

(72) Inventors: Fearghal O'DONNCHA, Galway (IE); Emanuele RAGNOLI, Dublin (IE); Ernesto ARANDIA, Dublin (IE); Sean A. MCKENNA, Blanchardstown (IE)

(73) Assignee: INTERNATIONAL BUSINESS MACHINES CORPORATION, Armonk, NY (US)

(21) Appl. No.: 15/865,532

(22) Filed: Jan. 9, 2018

(51) Int. Cl. A01K 61/90; G06N 99/00; A01G 7/00; A01G 2/00; A01K 61/10; A01K 61/50

(52) U.S. Cl. CPC A01K 61/90; G06N 99/005; A01K 61/50; A01G 2/00; A01K 61/10; A01G 7/00

(57) ABSTRACT

Embodiments for managing aquaculture production by one or more processors are described. Information associated with an aquaculture site is received. The information includes at least a current stocking density of the aquaculture site. A recommended time for harvesting is determined based on the received information. A signal representative of the recommended time for harvesting is generated.

### BACKGROUND OF THE INVENTION

### Field of the Invention

The present invention relates in general to computing systems, and more particularly, to various embodiments for managing aquaculture production.

### Description of the Related Art

Aquaculture, also known as aquafarming, is the farming (e.g., breeding, rearing, and harvesting) of aquatic organisms, such as fish, crustaceans, mollusks, and aquatic plants. Aquaculture involves cultivating freshwater and saltwater populations under controlled conditions, as opposed to commercial fishing, which is the harvesting of wild fish. The aquaculture industry has grown significantly over the past few decades, and according to some estimates, now accounts for approximately 50% of all fish and shellfish that is now directly consumed by humans.

However, the growth of the aquaculture industry in some regions has been limited due to, for example, production uncertainty and environmental concerns. These problems exist, at least in part, due to the lack of systems that provide accurate and timely information regarding production capacity, time to harvest, and the environmental impacts of aquaculture farms.

### SUMMARY OF THE INVENTION

Various embodiments for managing aquaculture production by one or more processors are described. In one embodiment, by way of example only, a method for managing aquaculture production, again by one or more processors, is provided. Information associated with an aquaculture site is received. The information includes at least a current stocking density of the aquaculture site. A recommended time for harvesting is determined based on the received information. A signal representative of the recommended time for harvesting is generated.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram depicting an exemplary computing node according to an embodiment of the present invention;

FIG. 2 is an additional block diagram depicting an exemplary cloud computing environment according to an embodiment of the present invention;

FIG. 3 is an additional block diagram depicting abstraction model layers according to an embodiment of the present invention;

FIG. 4 is a block/flow diagram illustrating certain aspects of functionality according to the present invention; and

FIG. 5 is a flowchart diagram depicting an exemplary method for managing aquaculture production in which various aspects of the present invention may be implemented.

### DETAILED DESCRIPTION OF THE DRAWINGS

As previously indicated, the aquaculture industry has grown significantly in recent years and accounts for a significant portion of the fish and shellfish that is now directly consumed by humans. However, the growth of the aquaculture industry in some regions has been limited due to, for example, production uncertainty and environmental concerns. These problems exist, at least in part, due to the lack of systems that provide accurate and timely information regarding production capacity, time to harvest, and the environmental impacts of aquaculture farms.

Current modeling of aquaculture operations involves mathematical modeling that investigates stocks and energy fluxes of aquaculture sites (or farms) and the potential interaction thereof with the environment. The modeling is typically performed during site construction (e.g., as part of an Environmental Impact Assessment (EIA) study), does not take changing conditions into consideration, and is often specific to a single species of organisms.

Indices based on comparisons of important oceanographic and biological processes are usually used to assess the carrying capacity of aquaculture sites. Such indices generally consider the site (e.g., a bay) as a homogenous system, which consequentially lacks spatial resolution. Simple thresholds of sustainability are often used to guide field testing and the associated remedial steps.

In view of the foregoing, a need exists for methods and systems for managing aquaculture production that, for example, provide accurate and timely information on production capacity (e.g., by weight and/or value), recommended times to harvest, and environmental impacts. Such methods and systems may reduce production uncertainty for aquaculture farms.

To address these needs, the methods and systems of the present invention utilize, for example, data driven computing to assess, update, predict, and/or optimize, for example, the production capacity of aquaculture sites, as well as provide users with recommendations with respect to the timing of harvesting and information related to environmental impacts of the operation of the site(s).

For example, in some embodiments, historical and real-time information related to an aquaculture site (or multiple aquaculture sites) is used to predict production output and/or capacity. A user (e.g., any appropriate personnel, such as a site manager) may be provided with information, or a recommendation, with respect to a time to harvest stock based on, for example, current stocking and/or other operational information. Also, various aspects of production may be optimized based on one or more defined objectives (e.g., minimize time to market, maximize total production, minimize/reduce environmental effects, etc.).

In some embodiments, a method for managing aquaculture production by one or more processors is provided. Information associated with an aquaculture site is received. The information includes at least a current stocking density of the aquaculture site. A recommended time for harvesting is determined based on the received information. A signal representative of the recommended time for harvesting is generated.

The received information may further include at least one of previous production of the aquaculture site and environmental metrics. The determining of the recommended harvest time is performed utilizing a machine learning technique.

A production output of the aquaculture site may be calculated based on the received information. A signal representative of the calculated production output may be generated.

The received information may further include a desired output of the aquaculture site. The desired output of the aquaculture site may be compared to the production capacity of the aquaculture site. A recommended stocking density may be determined based on the comparison of the desired output of the aquaculture site to the calculated production output of the aquaculture site.

In this manner, the methods and system described herein may provide a data-driven approach that leverages all available data to inform appropriate personnel (e.g., managers, stakeholders, etc.) of, for example, speed to harvest and total harvest size and/or value. This may reduce some of the uncertainties regarding aquaculture production due to, for example, the nature and level of risk associated with aquaculture investment, potentially allowing the aquaculture industry to be further developed in some countries.

Also provided are methods and/or systems that allow environmental impacts to be forecasted using historical and real-time information. This may be beneficial as aquaculture sites (or farms) are often subjected to significant regulatory controls that define the impact that the sites may have on the ecosystem and issuing of licenses for new sites.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

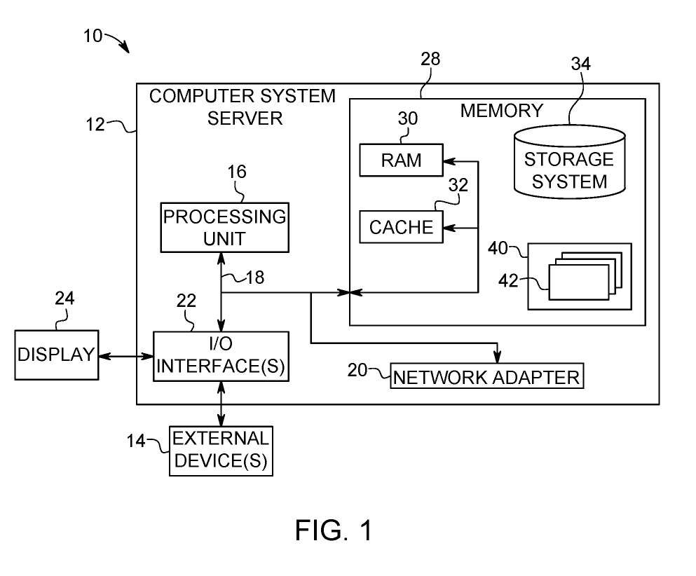

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing (or causing or enabling) any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, system memory 28 may include at least one program product having a set (e.g., at least one) of program modules that are configured to carry out the functions of embodiments of the invention.

Program/utility 40, having a set (at least one) of program modules 42, may be stored in system memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

In the context of the present invention, and as one of skill in the art will appreciate, various components depicted in FIG. 1 may be located in, for example, personal computer systems, hand-held or laptop devices, and network PCs. However, in some embodiments, some of the components depicted in FIG. 1 may be located in a computing device in a warehouse (e.g., at an aquaculture site), a vehicle (e.g., vessels, ships, or aircraft), and/or systems/devices that include one or more sensors (e.g., satellites, buoys, etc.). For example, some of the processing and data storage capabilities associated with mechanisms of the illustrated embodiments may take place locally via local processing components, while the same components are connected via a network to remotely located, distributed computing data processing and storage components to accomplish various purposes of the present invention. Again, as will be appreciated by one of ordinary skill in the art, the present illustration is intended to convey only a subset of what may be an entire connected network of distributed computing components that accomplish various inventive aspects collectively.

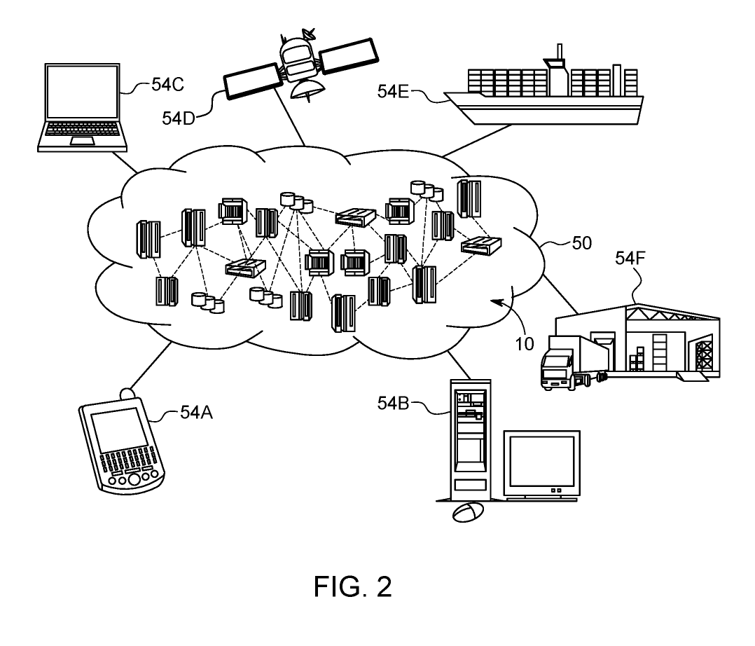

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, and/or laptop computer 54C, and others computer systems, such as, for example, those in satellites 54D, vessels 54E, and/or aquaculture farms 54F, may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-F shown in FIG. 2 are intended to be illustrative only and that computing nodes 10 and cloud computing environment 50 can communicate with any type of computerized device over any type of network and/or network addressable connection (e.g., using a web browser).

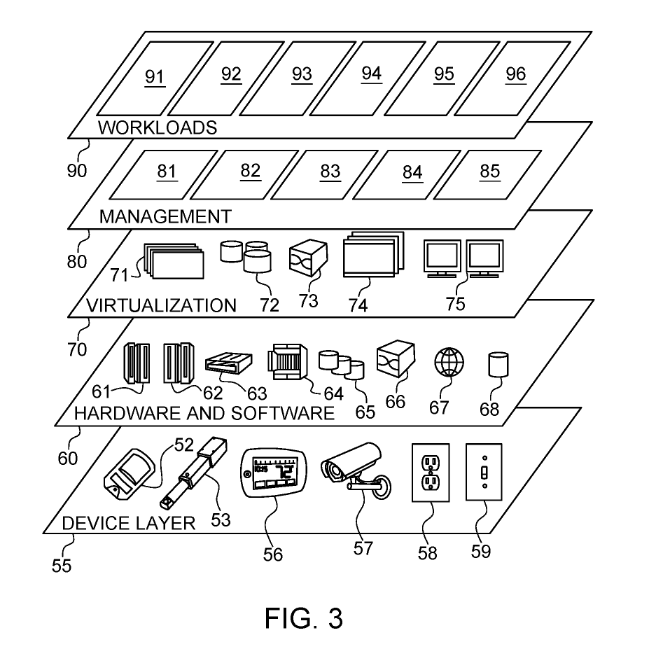

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Device layer 55 includes physical and/or virtual devices, embedded with and/or standalone electronics, sensors, actuators, and other objects to perform various tasks in a cloud computing environment 50. Each of the devices in the device layer 55 incorporates networking capability to other functional abstraction layers such that information obtained from the devices may be provided thereto, and/or information from the other abstraction layers may be provided to the devices. In one embodiment, the various devices inclusive of the device layer 55 may incorporate a network of entities collectively known as the “internet of things” (IoT). Such a network of entities allows for intercommunication, collection, and dissemination of data to accomplish a great variety of purposes, as one of ordinary skill in the art will appreciate.

Device layer 55 as shown includes sensor 52, actuator 53, “learning” thermostat 56 with integrated processing, sensor, and networking electronics, camera 57, controllable household outlet/receptacle 58, and controllable electrical switch 59 as shown. Other possible devices may include, but are not limited to drones, satellites, vessels, and various additional sensor devices, networking devices, electronics devices (such as a remote control device), additional actuator devices, so called “smart” appliances such as a refrigerator or washer/dryer, and a wide variety of other possible interconnected objects.

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, in the context of the illustrated embodiments of the present invention, various workloads and functions 96 for managing aquaculture production as described herein. One of ordinary skill in the art will appreciate that the workloads and functions 96 for managing aquaculture production may also work in conjunction with other portions of the various abstractions layers, such as those in hardware and software 60, virtualization 70, management 80, and other workloads 90 (such as data analytics processing 94, for example) to accomplish the various purposes of the illustrated embodiments of the present invention.

As previously mentioned, the methods and systems of the illustrated embodiments provide novel approaches for managing aquaculture production. In some embodiments, the methods and systems of the present invention utilize, for example, data driven computing to assess, update, and predict, for example, the production capacity of aquaculture sites, as well as provide users with recommendations with respect to the timing of harvesting and information related to environmental impacts of the operation of the site(s). For example, in some embodiments, historical and real-time information related to an aquaculture site (or multiple aquaculture sites) is used to predict production capacity. A user (e.g., any appropriate personnel, such as a site manager) may be provided with information, or a recommendation, with respect to a time to harvest stock based on, for example, current stocking and/or other operational information. Also, various aspects of production may be optimized based on one or more defined objectives (e.g., minimize time to market, maximize total production, minimize/reduce environmental effects, etc.).

In at least some embodiments, the methods and/or systems described herein utilize “machine learning,” “cognitive modeling,” “predictive analytics,” and/or “data analytics,” as is commonly understood by one skilled in the art. Generally, these processes may include, for example, receiving and/or retrieving multiple sets of inputs, and the associated outputs, of one or more systems and processing the data (e.g., using a computing system and/or processor) to generate or extract models, rules, etc. that correspond to, govern, and/or estimate the operation of the system(s). Utilizing the models, the performance (or operation) of the system (e.g., utilizing/based on new inputs) may be predicted and/or the performance of the system may be optimized by investigating how changes in the input(s) effect the output(s).

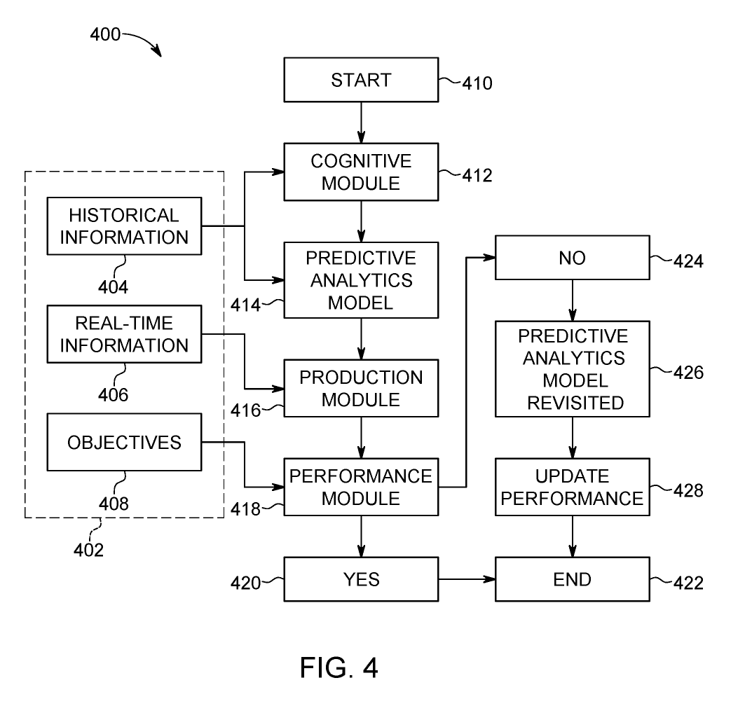

FIG. 4 is a simplified functional block diagram/flowchart of system (and/or method) 400 for managing aquaculture production, illustrating certain aspects of functionality according to some embodiments described herein. The system 400 includes (and/or receives) various inputs 402. In the depicted embodiment, the inputs 402 include historical information (or data) 404, real-time information 406, and objectives (or goals) 408.

The historical information 404 may include any information that is in any way related to and/or associated with the previous operation and/or production of one or more aquaculture sites. Examples of historical information may include, but are not limited to, species types, stocking density, harvested/production weight and/or total production, harvesting times, total time to market, environmental effects/metrics/impacts (e.g., dissolved oxygen, chlorophyll levels, etc.), weather information (e.g., temperature, precipitation, wind speed/direction, etc.), and information related to the water (e.g., temperature, salinity, currents, tides, aquatic epidemics, etc.).

The real-time information 406 may include any information that is in any way related to and/or associated with the current (i.e., present time) operation and/or production of one or more aquaculture sites (e.g., the same aquaculture site(s) associated with the historical information). Examples of real-time information may include, but are not limited to, the same types of information that may be included in the historical information (e.g., species types, stocking density, etc.) but associated with the present operation of the aquaculture site(s) as opposed to previous operation/production of the aquaculture site(s).

It should be noted that the historical information 404 and the real-time information 406 may be retrieved and/or received from both structured sources and unstructured sources. For example, structured sources of information or data may include relational databases, spreadsheets, etc. (human-generated and/or machine-generated). Unstructured sources may include human-generated data, such as text files (e.g., describing observations), social media posts, audio and/or video files, digital photos, as well as machine-generated data such as satellite imagery, scientific data, digital surveillance, and sensor data (e.g., from weather and/or oceanographic sensors). In some embodiments, the historical information 404 and/or the real-time information 406 is retrieved and/or monitored automatically by the systems described herein.

The objectives 408 may include any desired “output(s)” or result(s) (e.g., key performance indicators (KPIs)) related to the (current and/or future) operation of the aquaculture site(s). Examples include, but are not limited to, harvested/production weight and/or total production, speed to harvest and/or total time to market, and environmental effects. The objectives 408 may be set (and/or adjusted) by any appropriate personnel (e.g., a site manager, stakeholder, etc.) and/or may be set/adjusted (e.g., manually or automatically) in response to outside factors such as market demand, environmental conditions (e.g., weather), changes in environmental regulations, etc.

Still referring to FIG. 4, at block 410, analysis and/or assessment of the aquaculture site(s) is initiated by, for example, a site manager, a stakeholder, etc. In some embodiments, the analysis may be automatically initiated by a system monitoring the operation of the aquaculture site(s).

At block 412, the historical information 404 is sent to and/or retrieved by a cognitive module (and/or model) that uses aspects of cognitive computing to process the information. In some embodiments, the cognitive module parses and/or extracts particular aspects of the historical information, such as stocking density and other operational parameters and relates that information with, for example, the associated productivity and environmental impacts of the operation of the aquaculture site. At block 414, the historical information 404 and/or the particular aspects thereof extracted by the cognitive model is utilized to generate (and/or “build”) and train a predictive analytics model.

At block 416, the real-time information 406 is sent to and/or retrieved by a production module. The production module utilizes the real-time information 406 and the predictive analytics model (block 414) to, for example, predict (and/or calculate and/or determine) the “output” of the aquaculture site, such as production (or yield), environmental effects, etc. The production module may also generate recommendations for harvesting times (i.e., when to harvest/collect species) to, for example, maximize overall production (e.g., for a particular time frame).

At block 418, the objectives 408 are utilized to determine whether or not the aquaculture site is operating in a manner that will meet the desired outputs referred to in the objectives 408. That is, at block 418, a performance module receives and/or retrieves the objectives 408 and performs a comparison of the objectives 408 to the predicted output of the aquaculture site as generated by the production module. If it is determined that the aquaculture site is operating in a manner that is meeting (or will meet) the objectives 408 (block 420), the analysis/assessment of the aquaculture site may end at block 422 with, for example, an indication (and/or a signal representative thereof) being generated and provided to appropriate personnel (e.g., via electronic message, such as text or email, pop-up window on a display screen, etc.).

Still referring to FIG. 4, if it is determined that the aquaculture site(s) is not operating in a manner that is meeting/will meet the objectives 408 (block 424), at block 426, the predictive analytics model (block 414) is utilized to investigate ranges of inputs (e.g., those associated with the real-time information 406) to determine potential changes in the operation of the aquaculture site that may cause the aquaculture site to meet the desired output as indicated in the objectives 408. As one example, if the overall production of the site is lower than indicated by the objectives 408, a change in stocking density and/or harvesting times (and/or frequency thereof) may result in an increase in overall production. In some embodiments, this investigation is performed automatically. However, a user may (also) be provided with a user interface (e.g., via a computing device) that allows them to adjust or tune (i.e., “play with”) the various inputs to see how changes in variables (e.g., stocking density) effect the overall production and/or performance of the site.

At block 428, an indication (and/or a signal representative thereof) of the updated production output and the associated inputs/variables, as determined utilizing the predictive analytics model, is generated and provided to appropriate personnel (e.g., via electronic message, such as text or email, pop-up window on a display screen, etc.).

At block 422, the analysis/assessment ends with, for example, any appropriate changes to the operation of the aquaculture site being made (e.g., manually by appropriate personnel and/or automatically by automated systems).

As such, the system 400 utilizes historical information about the aquaculture site to create a predictive analytics model that may be used to predict various aspects of the current (and/or future) performance and/or productivity of the aquaculture site based on current, real-time information about the aquaculture site.

In some embodiments, systems (and/or methods) are provided that leverage historical data, predictive modeling and/or machine learning to, for example, optimize operation of aquaculture sites based on user defined objectives (e.g., KPIs), such as predicted time until harvest, value of harvest based on current stocking densities, optimum farm stocking densities to maintain environmental impact thresholds, etc. For example, embodiments described herein may merge historical and real-time information associated with aquaculture site operations and outputs along with information on environmental conditions from structured and unstructured sources. Additionally, the systems may utilize the historical and/or real-time information to enable predictions on farm outputs and productivity based on current operational configurations (e.g., stocking density, environmental metrics, etc.). Further, the systems may compute and output predicted results (e.g. time until harvest and value of harvest, environmental impact indices, etc.) and the difference between those results and the user defined objectives.

In some embodiments, systems (and/or methods) are provided that use the collated data to allow investigations (e.g., by personnel) of different stocking configurations and associated productivity and environmental impacts. Further, in some embodiments, systems (and/or methods) are provided that use the collated data and investigation(s) regarding stocking configurations, etc., to inform appropriate personnel of updated site operations to meet defined obj ectives.

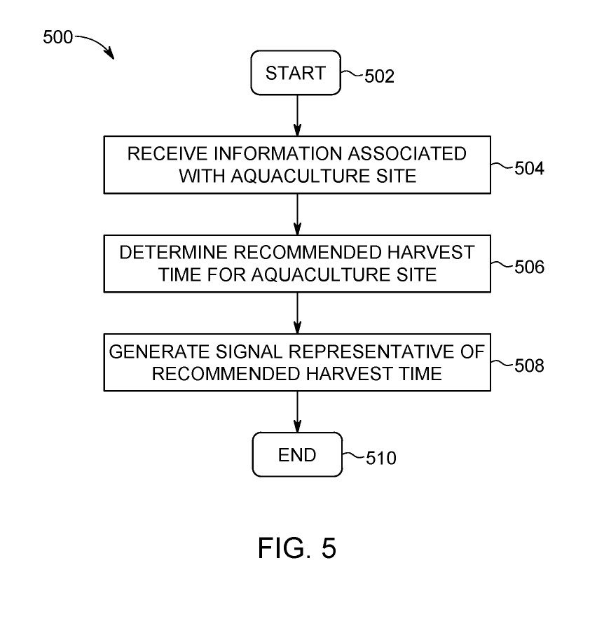

Turning to FIG. 5, a flowchart diagram of an exemplary method 500 for managing aquaculture production, in accordance with various aspects of the present invention, is illustrated. Method 500 begins (step 502) with, for example, an analysis and/or assessment of one or more aquaculture sites (or farms) being initiated (e.g., by appropriate personnel and/or automatically by a system monitoring the operation of the site(s)).

Information associated with the aquaculture site(s) is received (step 504). The received information may include historical information, real-time information, and/or objectives related to the operation and/or production of the aquaculture site. Examples of historical information include, for example, species type(s), stocking density, harvested/production weight and/or total production, harvesting times, total time to market, environmental effects/metrics/impacts, weather information, and information related to the water, associated with previous operation of the aquaculture site. Examples of real-time information may be similar to those of the historical information, but associated with the current/present operation of the aquaculture site. The historical information 404 and the real-time information 406 may be retrieved and/or received from both structured sources and unstructured sources. Additionally, the received information may (also) include desired output(s) or result(s) (e.g., KPIs) related to the (current and/or future) operation of the aquaculture site.

In some embodiments, using, for example, machine learning, predictive analytics, etc., the current (and/or future) production (or production output) of the aquaculture site is determined (calculated or predicted) based on the received information. The determination of the production of the aquaculture site may include determining a recommended harvest time (and/or frequency) and/or stocking density (or any other operational parameter) to, for example, achieve a particular output (e.g., maximize overall production, minimize environmental effects, etc.) (step 506).

A signal representative of the determined recommended harvest time and/or of the overall production output of the aquaculture site is generated (step 508). The generation of the signal may include providing an appropriate notification to one or more users (e.g., managers, stakeholders, etc.) via, for example, an electronic message (e.g., text message, email, etc.), visual messages (e.g., on display screens), and/or aural messages (e.g., recorded messages, buzzers, etc.).

Method 500 ends (step 510) with, for example, the completion of the analysis and/or assessment of the aquaculture site. In some embodiments, method 500 may be re-initiated by, for example, updated information (e.g., new real-time information) regarding the operation of the aquaculture site being received.

As such, in some embodiments, the methods and/or systems described herein provide recommendations with respect to the time to harvest based on, for example, current stocking densities, recommended stocking densities to achieve certain objectives (e.g., production per year, time to harvest, environmental/ecosystem impacts, etc.), and the ability to dynamically change (or at least investigate) operational parameters and receive updated metrics.

In some embodiments, the methods and/or systems utilize historical information on aquaculture operations (e.g., stocking densities, production, etc.) and environmental metrics (e.g., dissolved oxygen, chlorophyll, etc.). A module may be utilized that collates historical information related to operations and environmental conditions to relate aquaculture productivity to, for example, stocking densities and environmental metrics. A prediction module may be utilized (using the above data) to make predictions on operational output of the site(s) based on current configuration and environmental data. A module may be provided that allows a user to investigate different stocking configurations and associated productivity and environmental impacts. As a result, users may be dynamically and continuously provided with, for example, quantified measures of time to harvest and a production value of the harvest and allowed to optimize operational parameters (e.g., stocking densities) for defined conditions in real-time (speed to harvest, gross output, ecosystem impact, etc.).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowcharts and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowcharts and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

1. A method, by one or more processors, for managing aquaculture production, comprising:
receiving information associated with an aquaculture site, wherein the information includes at least a current stocking density of the aquaculture site;
determining a recommended time for harvesting based on the received information; and
generating a signal representative of the recommended time for harvesting.

2. The method of claim 1, wherein the received information further includes at least one of previous production of the aquaculture site and environmental metrics.

3. The method of claim 1, further comprising:
calculating a production output of the aquaculture site based on the received information; and
generating a signal representative of the calculated production output.

4. The method of claim 3, wherein the received information further includes a desired output of the aquaculture site.

5. The method of claim 4, further comprising comparing the desired output of the aquaculture site to the production capacity of the aquaculture site.

6. The method of claim 5, further comprising determining a recommended stocking density based on the comparison of the desired output of the aquaculture site to the calculated production output of the aquaculture site.

7. The method of claim 1, wherein the determining of the recommended harvest time is performed utilizing a machine learning technique.

8. A system for managing aquaculture production, comprising:
at least one processor that
receives information associated with an aquaculture site, wherein the information includes at least a current stocking density of the aquaculture site;
determines a recommended time for harvesting based on the received information; and
generates a signal representative of the recommended time for harvesting.

9. The system of claim 8, wherein the received information further includes at least one of previous production of the aquaculture site and environmental metrics.

10. The system of claim 8, wherein the at least one processor further:
calculates a production output of the aquaculture site based on the received information; and
generates a signal representative of the calculated production output.

11. The system of claim 10, wherein the received information further includes a desired output of the aquaculture site.

12. The system of claim 11, wherein the at least one processor further compares the desired output of the aquaculture site to the production capacity of the aquaculture site.

13. The system of claim 12, wherein the at least one processor further determines a recommended stocking density based on the comparison of the desired output of the aquaculture site to the calculated production output of the aquaculture site.

14. The system of claim 8, wherein the determining of the recommended harvest time is performed utilizing a machine learning technique.

15. A computer program product for managing aquaculture production by one or more processors, the computer program product comprising a non-transitory computer-readable storage medium having computer-readable program code portions stored therein, the computer-readable program code portions comprising:
an executable portion that receives information associated with an aquaculture site, wherein the information includes at least a current stocking density of the aquaculture site;
an executable portion that determines a recommended time for harvesting based on the received information; and
an executable portion that generates a signal representative of the recommended time for harvesting.

16. The computer program product of claim 15, wherein the received information further includes at least one of previous production of the aquaculture site and environmental metrics.

17. The computer program product of claim 15, wherein the computer-readable program code portions further include:
an executable portion that calculates a production output of the aquaculture site based on the received information; and
an executable portion that generates a signal representative of the calculated production output.

18. The computer program product of claim 17, wherein the received information further includes a desired output of the aquaculture site.

19. The computer program product of claim 18, wherein the computer-readable program code portions further include an executable portion that compares the desired output of the aquaculture site to the production capacity of the aquaculture site.

20. The computer program product of claim 19, wherein the computer-readable program code portions further include an executable portion that determines a recommended stocking density based on the comparison of the desired output of the aquaculture site to the calculated production output of the aquaculture site.

21. The computer program product of claim 15, wherein the determining of the recommended harvest time is performed utilizing a machine learning technique.
